(19) United States
(12) Patent Application Publication
(10) Pub. No.: US 2009/0117399 A1
(43) Pub. Date: May 7, 2009

(54) MULTI-LAYER POLYMER NANOCOMPOSITE PACKAGING FILMS

(75) Inventor: David A. Frecka, Lexington, OH (US)

Correspondence Address: HAHN LOESER & PARKS, LLP, One GOJO Plaza, Suite 300, AKRON, OH, 44311-1076, US

(73) Assignee: Next Generation Films, INC., Lexington, OH (US)

(21) Appl. No.: 11/933,726

(22) Filed: Nov. 1, 2007

(51) Int. Cl. B32B 27/08

(52) U.S. Cl. 428/474.7; 428/474.4; 428/476.9

(57) ABSTRACT

The invention relates to multi-layer polymer nanocomposite packaging films having barrier properties. A co-extruded multi-layer packaging film includes a plurality of thermoplastic polymer layers, at least one polyamide layer and an adhesive blended into at least one of the thermoplastic polymer and polyamide layers.

The invention relates to multi-layer packaging films. More particularly, the invention relates to multi-layer polymer nanocomposite packaging films. Even more particularly, the invention relates to multi-layer polymer nanocomposite packaging films having barrier properties.

### BACKGROUND OF THE INVENTION

It is known in the art to provide polyamide based packaging articles such as films, bottles, and containers, which are useful for food packaging. Many such articles are made of multiple layers of different plastics in order to achieve the desired barrier properties. In order to enhance freshness preservation, it is standard practice to package food and other materials within laminated packaging material that generally includes a barrier layer, that is, a layer having a low permeability to various gaseous materials.

In the field of plastic, nanocomposite materials are understood as polymer formulations which comprise finely dispersed particles such as clay minerals within the polymer matrix. The relevant aspect is that the particles are mixed within the polymer and then dispersed. The properties of such nanocomposites have already been published in numerous patent specifications and specialized publications. It is known that finely dispersed clay minerals provide the composite with improved properties such as increased mechanical strength, and improved barrier properties against gas molecules such as oxygen, carbon dioxide or aromatics through the packaging material.

Polyamides have been established for many years as preferred thermoplastic polymeric materials in the packaging field. One of the main reasons is the property profile of this class of materials, such as favorable barrier effect against oxygen and carbon dioxide as well as the outstanding mechanical properties of the packaging film made of polyamide. When using aliphatic polyamides as a matrix for nanocomposite materials, a reduction in the transparency can be observed because these nanocomposite filling materials are capable of increasing the crystallization of the aliphatic polyamides, which on the other hand can strongly impair the transparency of such products.

A desirable goal in the packaging field is the polyamide nanocomposite as a part of multi-layer films in combination with other polymers such as polyolefins. Multi-layer films which are composed of different types of polymers with mutual adverse adhesion can be rigidly connected with each other by suitable bonding layers. Such multi-layer films can be used to produce a large variety of packaging products such as containers, bottles, bags, thermomoldable products, tubes, etc. The products can be provided with a dyed, light-permeable or transparent configuration. In order to enable the successful marketing of a large variety of products, the presentation of these products towards the customer plays an increasingly important role. Numerous suitable barrier materials consist of aliphatic polymers. Such compounds usually crystallize during the cooling process and lead to packaging materials with reduced transparency.

Notwithstanding the state of the art as described herein, there is a need for further improvements in the preparation of multi-layer barrier packaging materials. Such materials can be prepared wherein an adhesive is dispersed into at least one layer of the multi-layer polymer nanocomposite film.

### SUMMARY OF THE INVENTION

The invention provides multi-layer barrier packaging films. In one embodiment of the invention, a multi-layer film includes a first layer of a first thermoplastic polymer, a second layer of a nanocomposite polyamide, wherein the nanocomposite polyamide further comprises an adhesive blended therein, and a third layer of a second thermoplastic polymer.

In another embodiment of the invention, a multi-layer film includes a first layer of a first thermoplastic polymer, wherein the first thermoplastic polymer further comprises a first adhesive blended therein, a second layer of a nanocomposite polyamide, and a third layer of a second thermoplastic polymer, wherein the second thermoplastic polymer further comprises a second adhesive blended therein.

In yet a further embodiment of the invention, a multi-layer film includes a first layer of a first thermoplastic polymer, wherein the first thermoplastic polymer further comprises a first adhesive blended therein, a second layer of a nanocomposite polyamide, wherein the polyamide nanocomposite material further comprises a second adhesive blended therein, and a third layer of a second thermoplastic polymer, wherein the second thermoplastic polymer further comprises a third adhesive blended therein.

In a further embodiment of the invention, a multi-layer film includes a first layer of a first thermoplastic polymer, wherein the first thermoplastic polymer further comprises a first adhesive blended therein, a second layer of a nanocomposite polyamide, a third layer of a second thermoplastic polymer, wherein the second thermoplastic polymer further comprises a second adhesive blended therein, a fourth layer of a nanocomposite polyamide, and a fifth layer of a third thermoplastic polymer, wherein the third thermoplastic polymer further comprises a third adhesive blended therein.

### BRIEF DESCRIPTION OF THE DRAWINGS

FIG. 1 is a cross-sectional view of a multi-layer film having three layers in one embodiment of the invention;

FIG. 2 is a cross-sectional view of a multi-layer film having three layers in another embodiment of the invention;

FIG. 3 is a cross-sectional view of a multi-layer film having three layers in yet a further embodiment of the invention; and

FIG. 4 is a cross-sectional view of a multi-layer film having five layers in one embodiment of the invention.

### DETAILED DESCRIPTION OF THE INVENTION

In one embodiment of the invention, a co-extruded multi-layer packaging film includes a plurality of thermoplastic polymer layers, at least one polyamide layer and an adhesive blended into at least one of the thermoplastic polymer and polyamide layers.

As used herein, the term “multi-layer” refers to a plurality of layers in a single film structure generally in the form of a sheet or web which can be made from a polymeric material or a non-polymeric material bonded together by any conventional means known in the art, i.e., extrusion, extrusion coating, and lamination, vacuum vapor deposition coating, solvent coating, emulsion coating, or suspension coating or a combination of one or more thereof. In one embodiment of the invention, the multi-layer film may include at least three layers and up to at least five layers. In another embodiment, the multi-layer film may include up to eleven layers.

As used herein, the phrase “thermoplastic material” refers to a polymer or polymer mixture that softens when exposed to heat and returns to its original condition when cooled to room temperature. In general, thermoplastic materials include, but are not limited to, synthetic polymers such as polyamides, polyolefins, polyalkyl acrylates, polyesters, ethylene/vinyl alcohol copolymers, and the like. Thermoplastic materials may also include any synthetic polymer that is cross-linked by either radiation or chemical reaction during a manufacturing process operation.

As used herein, the term “polymer” refers to the product of a polymerization reaction, and is inclusive of homopolymers, copolymers, terpolymers, etc. In general, the layers of a film can consist essentially of a single polymer, or can have still additional polymers together therewith, i.e., blended therewith.

In another embodiment of the invention, the thermoplastic polymer layer can be a thermoplastic material including polymers made from monomers including ethylene, propylene, butylene, butadiene, styrene and others. Moreover, such thermoplastic polymeric materials include poly(acrylonitrile-co-butadiene-co-styrene) polymers, acrylic polymers such as the polymethylmethacrylate, poly-n-butyl acrylate, poly(ethylene-co-acrylic acid), poly(ethylene-co-methacrylate), etc.; cellophane, cellulosics including cellulose acetate, cellulose acetate propionate, cellulose acetate butyrate and cellulose triacetate, etc.; fluoropolymers including polytetrafluoroethylene (Teflon®), poly(ethylene-co-tetrafluoroethylene) copolymers, (tetrafluoroethylene-co-propylene) copolymers, polyvinyl fluoride polymers, etc., polycarbonates; polyesters such as poly(ethylene-co-terephthalate), poly(ethylene-co-1,4-naphthalene dicarboxylate), poly(butylene-co-terephthalate); polyimide materials; polyethylene materials including low density polyethylene; linear low density polyethylene, high density polyethylene, high molecular weight high density polyethylene, etc.; polypropylene, biaxially oriented polypropylene; polystyrene, biaxially oriented polystyrene; high-impact polystyrene (mixture of polystyrene and polybutadiene) vinyl films including polyvinyl chloride, (vinyl chloride-co-vinyl acetate) copolymers, polyvinylidene chloride, polyvinyl alcohol, (vinyl chloride-co-vinylidene dichloride) copolymers, specialty films including polysulfone, polyphenylene sulfide, polyphenylene oxide, liquid crystal polyesters, polyether ketones, polyvinylbutyral, etc.

In an embodiment of the invention, the polyamide layer includes a polyamide homopolymer or copolymer selected from aliphatic polyamides and aliphatic/aromatic polyamides having a molecular weight of at least about 100,000 and can be greater than 500,000. General procedures useful for the preparation of polyamides are well known to the art. Useful diacids for making polyamides include dicarboxylic acids which are represented by the general formula:

HOOC-Z-COOH

wherein Z is representative of a divalent aliphatic radical containing at least 2 carbon atoms, such as adipic acid, sebacic acid, octadecanedioic acid, pimelic acid, suberic acid, azelaic acid, dodecanedioic acid, and glutaric acid. The dicarboxylic acids may be aliphatic acids, or aromatic acids such as isophthalic acid and terephthalic acid. Suitable diamines for making polyamides include those having the formula:

H₂N(CH₂)ₙNH₂

wherein n has an integer value of 1-16, and includes such compounds as trimethylenediamine, tetramethylenediamine, pentamethylenediamine, hexamethylenediamine, octamethylenediamine, decamnthylenediarmine, dodecamethylenediamine, hexadecamethylenediamine, aromatic diamines such as p-phenylenediamine, 4,4′-diaminodiphenyl ether, 4,4′-diaminodiphenyl sulphone, 4,4′-diaminodiphenylmethane, alkylated diamines such as 2,2-dimethylpentamethylenediamine, 2,2,4-trimethylhexamethylenediamine, and 2,4,4 trimethylpentamethylenediamine, as well as cycloaliphatic diamines, such as diaminodicyclohexylmethane, and other compounds. Other useful diamines include heptamethylenediamine, nonamethylenediamine, and the like.

Useful aliphatic polyamide homopolymers include, but are not limited to, poly(4-aminobutyric acid) (nylon 4), poly(6-aminohexanoic acid) (nylon 6, also known as poly(caprolactam)), poly(7-aminoheptanoic acid) (nylon 7), poly(8-aminooctanoic acid) (nylon 8), poly(9-aminononanoic acid) (nylon 9), poly(10-aminodecanoic acid) (nylon 10), poly(11-amioundecanoic acid) (nylon 11), poly(12-aminododecanoic acid) (nylon 12), poly(hexamethylene adipamide) (nylon 6,6), poly(hexamethylene sebacamide) (nylon 6,10), poly(heptamethylene pimelamide) (nylon 7,7), poly(octamethylene suberamide) (nylon 8,8), poly(hexamethylene azelamide) (nylon 6,9), poly(nonamethylene azelamide) (nylon 9,9), poly(decamethylene azelamide) (nylon 10,9), poly(tetramethylene adipamide (nylon 4,6), caprolactam/hexamethylene adipamide copolymer (nylon 6,6/6), hexamethylene adipamide/caprolactam copolymer (nylon 6/6,6), trimethylene adipamide/hexamethylene azelaiamide copolymer (nylon trimethyl 6,2/6,2), hexamethylene adipamide-hexamethylene-azelaiamide caprolactam copolymer, (nylon 6,6/6,9/6), poly(tetramethylenediamine-co-oxalic acid) (nylon 4,2), the polyamide of n-dodecanedioic acid and hexamethylenediamine (nylon 6,12), the polyamide of dodecamethylenediamine and n-dodecanedioic acid (nylon 12,12), as well as blends and copolymers thereof.

Exemplary aliphatic/aromatic polyamides include, but are not limited to, poly(2,2,2-trimethyl hexamethylene terephthalamide), poly(m-xylylene adipamide) (MXD6), poly(p-xylylene adipamide), poly(hexamethylene terephthalamide) (nylon 6,T), poly(hexamethylene isophthalamide) (nylon 6,I), poly(dodecamethylene terephthalamide), polyamide 6T/61, poly(tetramethylenediamine-co-isophthalic acid) (nylon 4,I), polyamide 6/MXT/I, polyamide MXDI, hexamethylene adipamide/hexamethylene-isophthalamide (nylon 6,6/6I), hexamethylene adipamide/hexamethyleneterephthalamide (nylon 6,6/6T) and as well as others which are not particularly delineated here. Blends of two or more aliphatic/aromatic polyamides and/or aliphatic polyamides can also be used. Aliphatic/aromatic polyamides can be prepared by known preparative techniques or can be obtained from commercial sources.

In another embodiment of the invention, the at least one polyamide layer further comprises nanometer scale dispersed clay or nano-clay particles to form a nanocomposite polyamide layer that acts as an oxygen and an aroma barrier layer. During the polyamide condensation synthesis, the nano-clay particles participate in the reaction along with the polyamide condensation reactants in situ thus creating a highly dispersed matrix of nano-clay particles in the polyamide continuous phase.

Examples of such clays include a natural or synthetic phyllosilicate such as montmorillonite, hectorite, vermiculite, beidilite, saponite, nontronite or synthetic fluoromica, which has been cation exchanged with a suitable salt. The clay is montmorillonite, bectorite or synthetic fluoromica. The fine dispersions of nanometer scale silicate platelets are obtained either via an in-situ polymerization of polyamide forming monomer(s) or via melt compounding of polyamide in the presence of the organoammonium salt treated clay. The clay has an average platelet thickness in the range of from about 1 nm to about 100 nm and an average length and average width each in the range of from about 50 nm to about 500 nm. It is present in the overall composition in an amount of from about 0% to about 10% by weight.

In yet a further embodiment of the invention, the multi-layer packaging film includes an adhesive blended into at least one of the thermoplastic polymer and/or polyamide layers. Some prior art multi-layer packaging films required the use of adhesive or tie layers to aid in the adhesion of adjacent layers of the packaging film. By blending in the adhesive into at least one of the thermoplastic polymer and/or polyamide layers, the need for an adhesive or tie layer is no longer required for the multi-layer packaging film of the invention.

Examples of adhesive materials include polyurethanes, vinyl acetate monomer and polymers based upon vinyl acetate including polyvinyl acetate and ethylene-vinyl acetate, epoxies, polyesters, acrylics, anhydride modified polyolefin and blends thereof. Modified polyolefin compositions include chemically modified ethylene polymers for example, copolymers of ethylene with esters of ethylenically unsaturated carboxylic acids, such as alkyl acrylates or methacrylates, graft copolymers of maleic acid or anhydride onto ethylene vinyl acetate copolymers, graft copolymers of fused ring carboxylic anhydrides onto polyethylene, resin mixtures of these and mixtures with polyethylene or copolymers of ethylene and alpha olefin.

In a further embodiment of the invention, the layers of the packaging film may optionally also include one or more conventional additives whose uses are well known to those skilled in the art. The use of such additives may be desirable in enhancing the processing of the compositions as well as improving the products or articles formed therefrom. Examples of such include: oxidative and thermal stabilizers, lubricants, mold release agents, flame-retarding agents, oxidation inhibitors, dyes, pigments and other coloring agents, ultraviolet light stabilizers, organic or inorganic fillers including particulate and fibrous fillers, reinforcing agents, nucleators, plasticizers, as well as other conventional additives known to the art. These additives may be used in amounts ranging from about 1-2% by weight up to about 70% by weight of the overall composition.

Representative ultraviolet light stabilizers include various substituted resorcinols, salicylates, benzotriazole, benzophenones, and the like. Suitable lubricants and mold release agents include stearic acid, stearyl alcohol, and stearamides. Exemplary flame-retardants include organic halogenated compounds, including decabromodiphenyl ether and the like as well as inorganic compounds. Suitable coloring agents including dyes and pigments include cadmium sulfide, cadmium selenide, titanium dioxide, phthalocyanines, ultramarine blue, nigrosine, carbon black and the like. Representative oxidative and thermal stabilizers include the Periodic Table of Element's Group I metal halides, such as sodium halides, potassium halides, lithium halides; as well as cuprous halides; and further, chlorides, bromides, iodides. Also, hindered phenols, hydroquinones, aromatic amines as well as substituted members of those above mentioned groups and combinations thereof. Exemplary plasticizers include lactams such as caprolactam and lauryl lactam, sulfonamides such as o,p-toluenesulfonamide and N-ethyl, N-butyl benzylnesulfonamide, and combinations of any of the above, as well as other plasticizers known to the art.

Suitable fillers include inorganic fillers, including those of fibrous and granular nature, as wells as mixtures thereof. The fibrous fillers include glass, silica glass, ceramic, asbestos, alumina, silicon carbide, gypsum, metal (including stainless steel) as well as other inorganic and carbon fibers. The granular fillers include wollastonite, sericite, asbestos, talc, mica, clay, kaolin, bentonite, and silicates, including alumina silicate. Other granular fillers include metal oxides, such as alumina, silica, magnesium oxide, zirconium oxide, titanium oxide. Further granular fillers include carbonates such as calcium carbonate, magnesium carbonate, and dolomite, sulfates including calcium sulfate and barium sulfate, boron nitride, glass beads, silicon carbide, as well as other materials not specifically denoted here. These fillers may be hollow, for example glass microspheres, silane balloon, carbon balloon, and hollow glass fiber. Preferred inorganic fillers include glass fibers, carbon fibers, metal fibers, potassium titanate whisker, glass beads, glass flakes, wollastonite, mica, talc, clay, titanium oxide, aluminum oxide, calcium carbonate and barium sulfate. Particularly, glass fiber is most preferred. The inorganic fillers should preferably be treated with silane, titanate, or another conventional coupling agent, and glass fibers should preferably be treated with an epoxy resin, vinyl acetate resin or other conventional converging agent.

The multilayered barrier articles of this invention can be formed by any conventional technique for forming films; blown film extrusion, cast film extrusion, lamination, machine direction (MD) film orientation, transverse direction (TD) film orientation, biaxial film orientation, extrusion coating, solution coating, in other words any of the normal manufacturing processes. In one embodiment of the invention, the method for making the multilayer film is by an extrusion process. For example, in the extrusion process, the materials are feed to extruder(s) and then melt extruded into one or more layers. The layers can be formed initially in a die block or in a multi-channel die. If the layers are formed in a die block, they are subsequently reshaped, maintaining the original juxtapositions, into a high aspect ratio film or sheet. In a multi-channel die, the materials for an individual layer are formed into a high aspect ratio film in the channel, but are isolated from the material of a second or third layer until it exits the individual channel. The exit point of the channel may exist inside the die for outside the die. The layers may therefore be adhered each other inside the die, still under pressure, or outside the die, under atmospheric conditions. The adherence point may also be at the actual exit of the die.

In another method, the film forming apparatus may be one which is referred to in the art as a blown film apparatus and includes a multi-manifold circular die head for bubble blown film through which the plasticized film composition is forced and formed into a film bubble which may ultimately be collapsed and formed into a film.

In the lamination processes which includes thermal, extrusion, adhesive, and pressure, the material made by any of the film forming manufacturing processes are adhered to one another to make the multilayer structure. One or several layers can be added to an existing film through lamination by extruding them onto existing layers or a layer can be coated on as a solution by any of the well known coating processes.

In one embodiment of the invention, the thickness of each layer of the packaging film can be from about 0.05 mils (1.25 μm) to about 100 mils (2540 μm). In a further embodiment of the invention, the thickness of each layer of the packaging film can be from about 0.05 mils (1.3 μm) to about 50 mils (1270 μm). While such thicknesses are preferred as providing a readily flexible film, it is to be understood that other film thicknesses may be produced to satisfy a particular need and yet fall within the scope of the invention including plates, thick films, and sheets which are not readily flexible at room temperature (approx. 20° C.).

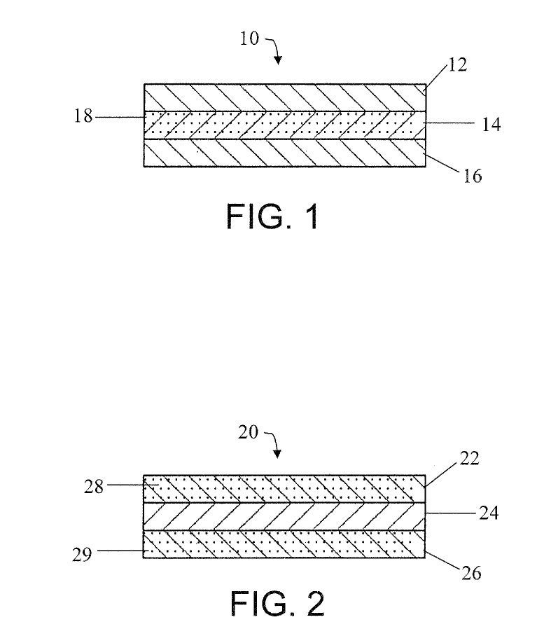

Referring now to FIG. 1, multi-layer film 10 represents an example of a three-layer barrier film in an embodiment of the invention. Film 10 includes a first layer 12 of a first thermoplastic polymer, a second layer 14 of a nanocomposite polyamide and a third layer 16 of a second thermoplastic polymer, wherein second layer 14 is positioned between first layer 12 and third layer 16. In one embodiment of the invention, second layer 14 includes adhesive 18 blended within the nanocomposite polyamide. During a co-extrusion process to prepare multi-layer film 10, adhesive 18 promotes the adhesion between first layer 12 and second layer 14 as well as the adhesion between third layer 16 and second layer 14. Thus, including adhesive 18 within the nanocomposite polyamide eliminates the need for a separate adhesive or tie layer typically required in prior art multi-layer packaging films.

Referring now to FIG. 2, a multi-layer film 20 represents an example of a three-layer barrier film in an embodiment of the invention. Film 20 includes a first layer 22 of a first thermoplastic polymer, a second layer 24 of a nanocomposite polyamide and a third layer 26 of a second thermoplastic polymer, wherein second layer 24 is positioned between first layer 22 and third layer 26. In one embodiment of the invention, first layer 22 includes a first adhesive 28 blended within the thermoplastic polymer and third layer 26 includes a second adhesive 29 blended within the thermoplastic polymer. During a co-extrusion process to prepare multi-layer film 20, adhesive 28 promotes the adhesion between first layer 22 and second layer 24 and adhesive 29 promotes the adhesion between third layer 26 and second layer 24. Thus, including adhesive 28 within the thermoplastic polymer of first layer 22 and adhesive 29 within the thermoplastic polymer of third layer 26 eliminates the need for a separate adhesive or tie layer typically required in prior art multi-layer packaging films.

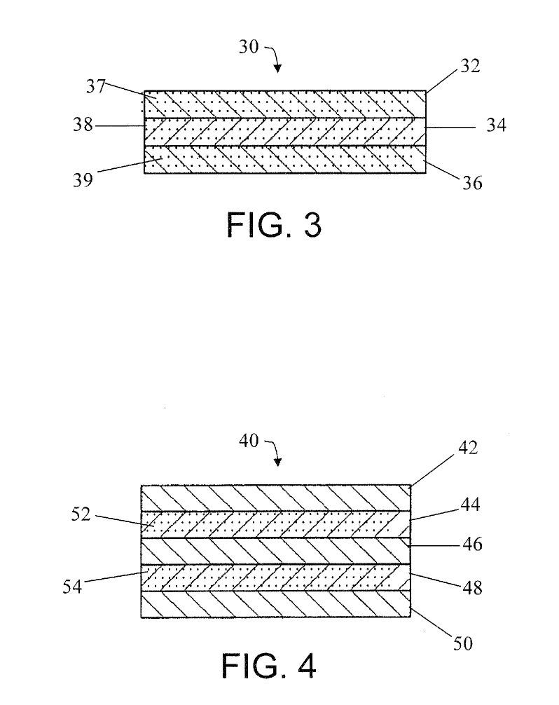

Referring now to FIG. 3, a multi-layer film 30 represents an example of a three-layer barrier film in an embodiment of the invention. Film 30 includes a first layer 32 of a first thermoplastic polymer, wherein the first thermoplastic polymer includes a first adhesive 37 blended therein, a second layer 34 of a nanocomposite polyamide, wherein the polyamide nanocomposite includes a second adhesive 38 blended therein, and a third layer 36 of a second thermoplastic polymer, wherein the second thermoplastic polymer includes a third adhesive 39 blended therein. Second layer 34 is positioned between first layer 32 and third layer 36. During a co-extrusion process to prepare multi-layer film 30, adhesives 37 and 38 promote the adhesion between first layer 32 and second layer 34 and adhesives 38 and 39 promote the adhesion between second layer 34 and third layer 36. Thus, including adhesive 37 within the thermoplastic polymer of first layer 32, adhesive 38 within the polyamide nanocomposite of second layer 34 and adhesive 39 within the thermoplastic polymer of third layer 36 eliminates the need for a separate adhesive or tie layer typically required in prior art multi-layer packaging films.

Referring now to FIG. 4, a multi-layer film 40 represents an example of a five-layer barrier film in an embodiment of the invention. Film 40 includes a first layer 42 of a first thermoplastic polymer, a second layer 44 of a first nanocomposite polyamide, a third layer 46 of a second thermoplastic polymer, a fourth layer 48 of a second nanocomposite polyamide and a fifth layer 50 of a third thermoplastic polymer. The construction of film 40 includes second layer 44 positioned between first layer 42 and third layer 46 and fourth layer 48 positioned between third layer 46 and fifth layer 50. In one embodiment of the invention, second layer 44 includes a first adhesive 52 blended within the nanocomposite polyamide of second layer 44 and a second adhesive 54 blended within the nanocomposite polyamide of fourth layer 48. During a co-extrusion process to prepare multi-layer film 40, adhesive 52 promotes the adhesion between first layer 42, second layer 44 and third layer 46 and adhesive 54 promotes the adhesion between third layer 46, fourth layer 48 and fifth layer 50. Thus, including adhesive 52 within the polyamide nanocomposite of second layer 44 and adhesive 54 within the polyamide nanocomposite of fourth layer 48 eliminates the need for a separate adhesive or tie layer typically required in prior art multi-layer packaging films.

Based upon the foregoing disclosure, it should now be apparent that the multi-layer polymer nanocomposite packaging films as described herein will carry out the objects set forth hereinabove. It is, therefore, to be understood that any variations evident fall within the scope of the claimed invention and thus, the selection of specific component elements can be determined without departing from the spirit of the invention herein disclosed and described.

What is claimed is:

1. A multi-layer film comprising:
a first layer of a first thermoplastic polymer;
a second layer of a nanocomposite polyamide, wherein the nanocomposite polyamide further comprises an adhesive blended therein; and
a third layer of a second thermoplastic polymer.

2. The film of claim 1, wherein the first thermoplastic polymer is polyethylene.

3. The film of claim 1, wherein the second thermoplastic polymer is polyethylene.

4. The film of claim 1, wherein the film is a co-extruded multi-layer film.

5. A multi-layer film comprising:
a first layer of a first thermoplastic polymer, wherein the first thermoplastic polymer further comprises a first adhesive blended therein;
a second layer of a nanocomposite polyamide; and
a third layer of a second thermoplastic polymer, wherein the second thermoplastic polymer further comprises a second adhesive blended therein.

6. The film of claim 5, wherein the first thermoplastic polymer is polyethylene.

7. The film of claim 5, wherein the second thermoplastic polymer is polyethylene.

8. The film of claim 5, wherein the film is a co-extruded multi-layer film.

9. A multi-layer film comprising:
a first layer of a first thermoplastic polymer, wherein the first thermoplastic polymer further comprises a first adhesive blended therein;
a second layer of a nanocomposite polyamide, wherein the polyamide nanocomposite material further comprises a second adhesive blended therein; and
a third layer of a second thermoplastic polymer, wherein the second thermoplastic polymer further comprises a third adhesive blended therein.

10. The film of claim 9, wherein the first thermoplastic polymer is polyethylene.

11. The film of claim 9, wherein the second thermoplastic polymer is polyethylene.

12. The film of claim 9, wherein the film is a co-extruded multi-layer film.

13. A multi-layer film comprising:
a first layer of a first thermoplastic polymer, wherein the first thermoplastic polymer further comprises a first adhesive blended therein;
a second layer of a nanocomposite polyamide;
a third layer of a second thermoplastic polymer, wherein the second thermoplastic polymer further comprises a second adhesive blended therein;
a fourth layer of a nanocomposite polyamide; and
a fifth layer of a third thermoplastic polymer, wherein the third thermoplastic polymer further comprises a third adhesive blended therein.

14. The film of claim 13, wherein the first thermoplastic polymer is polyethylene.

15. The film of claim 13, wherein the second thermoplastic polymer is polyethylene.

16. The film of claim 13, wherein the film is a co-extruded multi-layer film.
